(19) United States
(12) Patent Application Publication
(10) Pub. No.: US 2007/0264924 A1
(43) Pub. Date: Nov. 15, 2007

(54) Vehicle Glazing

(75) Inventors: Jussi Pekka Puotunen, Uusikaupunki (FI); Harri Tapani Kuusela, Tampere (FI)

Correspondence Address: BUCHANAN, INGERSOLL & ROONEY PC, POST OFFICE BOX 1404, ALEXANDRIA, VA, 22313-1404, US

(73) Assignee: PILKINGTON AUTOMO TIVE FINLAND OY, Tampere (FI)

(21) Appl. No.: 11/663,269

(22) PCT Filed: Sep. 16, 2005
(86) PCT No.: PCT/IB05/03327

§ 371 Date: Apr. 19, 2007

(30) Foreign Application Priority Data
Sep. 21, 2004 (GB) 0420920.1
May 20, 2005 (GB) 0510291.8

(51) Int. Cl. B60J 1/00

(52) U.S. Cl. 454/134

(57) ABSTRACT

The present invention relates to vehicle glazing, in particular to hinged windows for land vehicles such as buses, trams and trains, in particular slow speed trains. A hinged window for a land vehicle, comprises a fixed glazing panel defining an opening therein, a moving glazing panel, a hinge mechanism attached to the moving glazing panel, the moving glazing panel being pivotally movable by said hinge mechanism between a closed position, at which the moving glazing panel is received in the opening, and an open position, and a biasing mechanism for urging said moving glazing panel towards the closed position, the biasing mechanism including at least one elongate spring extending substantially orthogonally to the pivot axis of the moving glazing panel relative to the fixed glazing panel.

The present invention relates to vehicle glazing, in particular to hinged windows for land vehicles such as buses, trams and trains, in particular slow speed trains.

It is known to provide openable side windows for land vehicles such as buses, trams and trains, in particular slow speed trains. Such windows may have a moving glazing adjacent to a fixed glazing, and the moving glazing may be articulated or hinged, or sliding, relative to the fixed glazing.

Known hinged windows, particularly for buses, typically have a relatively narrow elongate generally rectangular moving glazing disposed at an upper edge of the associated fixed glazing. The hinge extends along and is affixed to the lower edge of the moving glazing and is affixed to an upper edge of the fixed glazing. Stops are provided for limiting the extent of opening of the moving glazing. A locking mechanism, incorporating a catch, is disposed at the upper edge of the moving glazing, with the catch being selectively held in a slot affixed to the vehicle body to retain the moving glazing securely in the closed position.

Modern hinged windows, particularly for buses, incorporate in the hinge mechanism a biasing device which urges the moving glazing towards the closed or open position. The biasing device incorporates a blade spring which extends along the hinge, and which flips or snaps between two positions, corresponding to the closed and open positions of the moving glazing. This biasing device has a snap action, which is clumsy and often difficult to manipulate by users. Also, the hinge and biasing device need to be incorporated into a rather complicated housing which extends horizontally along the window along its inside face, covering the junction between the fixed and moving panels. This housing is bulky and not aesthetically pleasing. The large housing correspondingly requires a large obscuration band to be applied to the glazings. This restricts the amount of light transmissive area of the window.

The biasing device, because of the limitations of its structure, using an elongate blade spring, does not have a particularly strong restoring force to close the moving glazing. This restricts the dimensions of the moving glazing, because the weight of the moving glazing is limited by the strength of the restoring force. In particular, this tends to restrict the available height for a moving glazing for a given window width. In addition, the limited strength of the restoring force tends to require the moving glazing to be single glazed, because a double glazed unit, like the fixed glazing, while clearly desirable would have excess weight to be reliably operated by the biasing device.

The known horizontal hinge mechanisms incorporating an integral biasing device also require a significant weight to be borne by the lower fixed glazing to which the known horizontal hinge mechanism is mounted. This in turn requires the lower fixed glazing to comprise sufficiently thick panes to be able structurally to bear the load of the horizontal hinge mechanisms. It would be desirable to be able to use thinner panes for the lower glazing.

The known horizontal hinge mechanisms can also tend to suffer from problems of water ingress due to insufficient or unreliable sealing at the junction between the moving and fixed glazings.

In the known windows incorporating the horizontal hinge mechanisms, when one or other of the moving or fixed glazings requires replacement, for example as a result of having been destroyed or damaged, the entire window requires replacement because of the two glazings having been assembled together using a complicated factory fitted hinge mechanism.

As disclosed in EP-A-0778168, there is a need in the art, particularly for bus windows, for the window to be mounted flush with the vehicle body, and for the moving glazing to be completely surrounded by the fixed glazing, as a result of the moving glazing being located in a closed opening of the fixed glazing. As well known in the art, a horizontal hinge is fitted between the fixed and moving glazings. EP-A-0778168 does not disclose the structure of any biasing mechanism for the moving glazing when the latter is hingedly attached to the fixed glazing. Although EP-A-0778168 discloses a structure for fitting the moving glazing so that it is completely surrounded by the fixed glazing, and moreover is supported by the vehicle body so that breakage of the fixed glazing would not leave the moving glazing unsupported and liable to fall on to passengers, nevertheless the hinge structure still inhibits the use of moving glazings of grater weight or dimension if a known biasing mechanism were to be incorporated into the design.

The present invention aims at least partially to obviate or overcome one or more of these problems of known hinged vehicle windows.

Accordingly, the present invention provides a hinged window for a land vehicle, comprising a fixed glazing panel defining an opening therein, a moving glazing panel, a hinge mechanism attached to the moving glazing panel, the moving glazing panel being pivotally movable by said hinge mechanism between a closed position, at which the moving glazing panel is received in the opening, and an open position, and a biasing mechanism for urging said moving glazing panel towards the closed position, the biasing mechanism including at least one elongate spring extending substantially orthogonally to the pivot axis of the moving glazing panel relative to the fixed glazing panel.

Preferably, the biasing mechanism comprises a helical compression spring, and a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the helical compression spring biasing the rocking member selectively towards one of the first and second stop positions from a central unstable position of the rocking member.

Preferably, the biasing mechanism further includes a damping device for damping the pivotal movement of the moving glazing panel.

More preferably, the damping device comprises a pneumatic cylinder having a telescope configuration and a vent for controllably venting a central chamber of the pneumatic cylinder during compression and expansion of the telescope configuration.

More preferably, the at least one elongate spring is disposed in the central chamber of the pneumatic cylinder.

Optionally, the length of the pneumatic cylinder is adjustable thereby to adjust the degree of bias applied by the at least one elongate spring.

Preferably, the biasing mechanism further includes a locking device for locking the angular position of the rotatable moving glazing panel.

Preferably, the hinge mechanism includes opposed pivot bars affixed to the moving glazing panel and the biasing mechanism includes two elongate springs, each mounted in a respective housing assembly and acting on a respective pivot bar.

The opposed pivot bars may extend from a hinge bar affixed to an edge of the moving glazing panel and each housing assembly of the biasing mechanism may be mounted to the vehicle body.

Preferably, each housing assembly of the biasing mechanism is either directly mounted to the vehicle body, or indirectly mounted to the vehicle body via a mounting element disposed against the fixed glazing panel.

Preferably, the mounting element comprises at least one support disposed against an edge of the fixed glazing panel.

More preferably, the at least one support has an outer face presenting a lip for diverting rainwater away from the window surface.

In another preferred arrangement, the opposed pivot bars are each attached to a respective hinge mount affixed to the fixed glazing panel and each housing assembly of the biasing mechanism is mounted to the moving glazing panel.

In a further preferred arrangement, the opposed pivot bars are each attached to a respective hinge mount affixed to the moving glazing panel and each housing assembly of the biasing mechanism is mounted to the fixed glazing panel.

In one preferred embodiment, the hinge mechanism includes at least one hinge bar affixed to the moving glazing panel and a mount for the hinge bar, the mount being affixed to a portion of an outer face of the fixed glazing panel extending along an edge of the opening.

Preferably, the mount has an elbow portion, an end part being adjacent to the outer face of the fixed glazing panel along a lower edge of the opening and an adjacent part disposed against an upwardly-facing edge of the fixed glazing panel.

Preferably, the end part is adhered to the outer face of the fixed glazing panel.

Preferably, the hinge bar and the mount have complementary hinge parts fitted together.

Preferably, two biasing mechanisms are provided, each one on a respective side of the moving glazing panel, and the biasing mechanisms are mounted to the vehicle body.

Preferably, each biasing mechanism is indirectly mounted to the vehicle body via a mounting element disposed against the fixed glazing panel.

Preferably, the mounting element comprises at least one support disposed against of the fixed glazing panel and affixed to the vehicle body.

Preferably, each biasing mechanism comprises a gas spring.

Preferably, the biasing mechanism is connected to the hinge mechanism by a rocker member rotatable, about a pivot, between first and second positions, respectively corresponding to the closed and open positions of the moving glazing panel, the biasing mechanism biasing the rocker member selectively towards one of the first and second positions from a central unstable position of the rocker member.

Preferably, the rocker member is pivotally connected to the hinge bar by a linking element pivotally connected to the rocker member and the hinge bar.

Preferably, the opening in the fixed glazing panel is closed whereby the fixed glazing panel surrounds the moving glazing panel, or the opening in the fixed glazing panel partially surrounds the moving glazing panel which is mounted at an edge of the window.

The present invention further provides a hinged window for a land vehicle, comprising a fixed glazing panel defining an opening therein, a moving glazing panel, a hinge mechanism attached to the moving glazing panel, the moving glazing panel being pivotally movable by said hinge mechanism between a closed position, at which the moving glazing panel is received in the opening, and an open position, and a biasing mechanism for urging said moving glazing panel towards the closed position, the biasing mechanism including a damping device for damping the pivotal movement of the moving glazing panel.

Preferably, the biasing mechanism comprises a helical compression spring, and the damping device comprises a pneumatic cylinder having a telescope configuration and a vent for controllably venting a central chamber of the pneumatic cylinder during compression and expansion of the telescope configuration, and the helical compression spring is disposed in the central chamber of the pneumatic cylinder.

More preferably, the length of the pneumatic cylinder is adjustable thereby to adjust the degree of bias applied by the helical compression spring.

Preferably, the hinged window further comprises a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the helical compression spring biasing the rocking member selectively towards one of the first and second stop positions from a central unstable position of the rocking member.

More preferably, the hinged window further includes a locking device for locking the angular position of the rocking member thereby to lock the position of the rotatable moving glazing panel.

The present invention also provides a bus, tram or train window, comprising a fixed glazing panel defining an opening therein, a moving glazing panel, a hinge mechanism attached to the moving glazing panel, the moving glazing panel being pivotally movable about a horizontal axis by said hinge mechanism between a closed position, at which the moving glazing panel is received in the opening, and an open position, the hinge mechanism comprising a pair of horizontally spaced hinges each mounted between the moving glazing panel and one of the fixed glazing panel and the vehicle body, a biasing mechanism for urging said moving glazing panel towards the closed position and a damping device for damping the pivotal movement of the moving glazing panel.

Preferably, the biasing mechanism comprises a helical compression spring, and a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the helical compression spring biasing the rocking member selectively towards one of the first and second stop positions from a central unstable position of the rocking member.

More preferably, the damping device comprises a pneumatic cylinder having a telescope configuration and a vent for controllably venting a central chamber of the pneumatic cylinder during compression and expansion of the telescope configuration.

Preferably, the at least one elongate spring is disposed in the central chamber of the pneumatic cylinder.

Preferably, in the bus, tram or train the hinges are each mounted between the moving glazing panel and the vehicle body, and further comprising fixings for temporarily attaching the hinge mechanism to the fixed glazing panel prior to attachment to the vehicle body.

The present invention yet further provides a bus, tram or train window, comprising a fixed glazing panel defining an opening therein, a moving glazing panel, a hinge mechanism attached to the moving glazing panel, the moving glazing panel being pivotally movable about a horizontal axis by said hinge mechanism between a closed position, at which the moving glazing panel is received in the opening, and an open position, a biasing mechanism for urging said moving glazing panel towards the closed position, the hinge mechanism comprising a pair of horizontally spaced hinges each mounted between the moving glazing panel and the vehicle body whereby the moving glazing panel can be replaced with the fixed glazing panel fitted to the vehicle.

The hinged window may further comprise fixings for temporarily attaching the hinge mechanism to the fixed glazing panel prior to attachment to the vehicle body.

Preferably, the moving glazing panel is pivotally movable about a horizontal axis along a lower edge of the moving glazing panel, the lower edge of the moving glazing panel being adjacent an upper edge of the opening in the fixed glazing panel, and further comprising at least one gasket disposed between the lower edge of the moving glazing panel and the upper edge of the opening in the fixed glazing panel so as to seal the interior of the vehicle against water ingress along the adjacent lower and upper edges when the moving glazing panel is in the closed and open positions.

The present invention also provides a bus, tram or train window, comprising a fixed glazing panel defining an opening therein and a moving glazing panel, both the fixed glazing panel and the moving glazing panel being double glazed units, a hinge mechanism attached to the moving glazing panel, the moving glazing panel being pivotally movable about a horizontal axis by said hinge mechanism between a closed position, at which the moving glazing panel is received in the opening, and an open position, the hinge mechanism being mounted between a lower horizontal edge of the moving glazing panel and the vehicle body, and a biasing mechanism mounted on the vehicle body for urging said moving glazing panel towards the closed position.

Embodiments of the present invention will now be described by way of example only with reference to the accompanying drawings, in which:

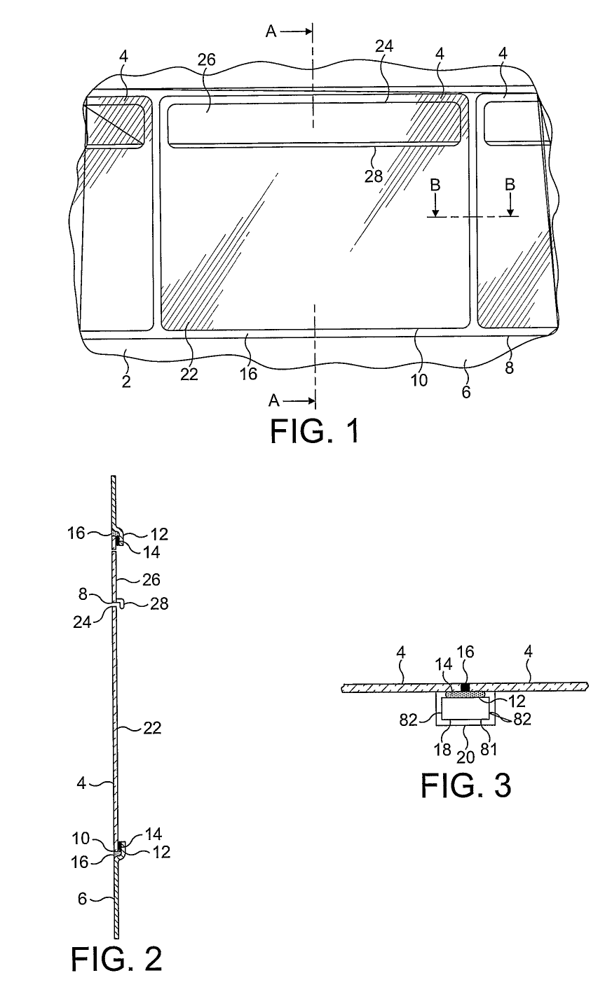

FIG. 1 is a schematic elevation view of part of an outer side of a bus incorporating a series of hinged windows for a vehicle in accordance with a first embodiment of the present invention,

FIG. 2 is a schematic vertical section on line A-A of the hinged window of FIG. 1,

FIG. 3 is a schematic horizontal section on line B-B of the hinged window of FIG. 1,

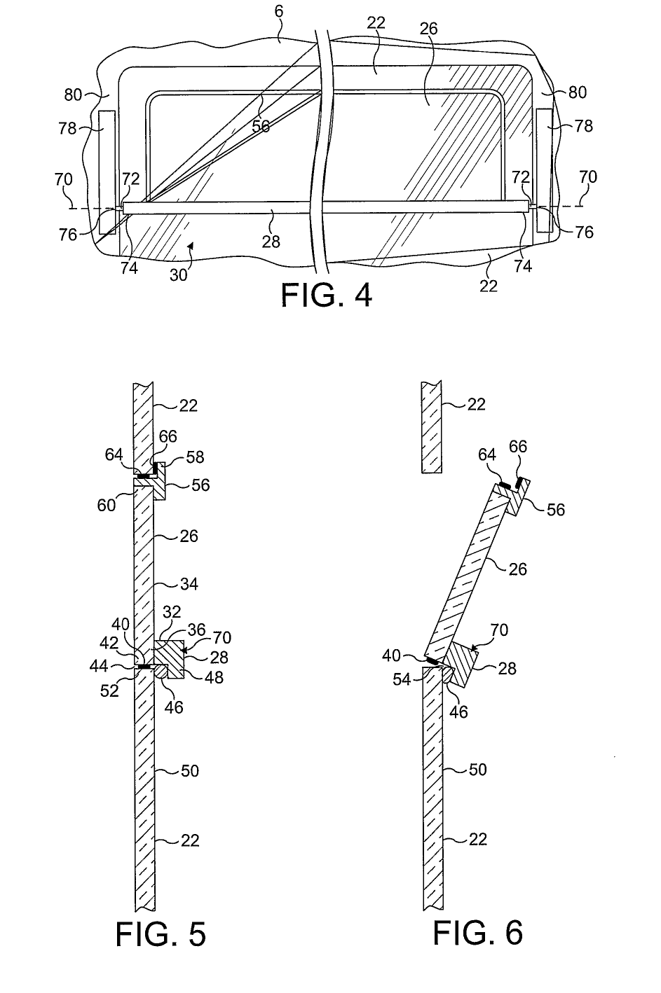

FIG. 4 is a schematic elevation view of the inner side of an upper portion of one of hinged windows of FIG. 1 showing the hinge mechanism,

FIG. 5 is a schematic vertical section on line C-C of the hinged window of FIG. 4 in a closed configuration,

FIG. 6 is a schematic vertical section on line C-C of the hinged window of FIG. 4 in an open configuration,

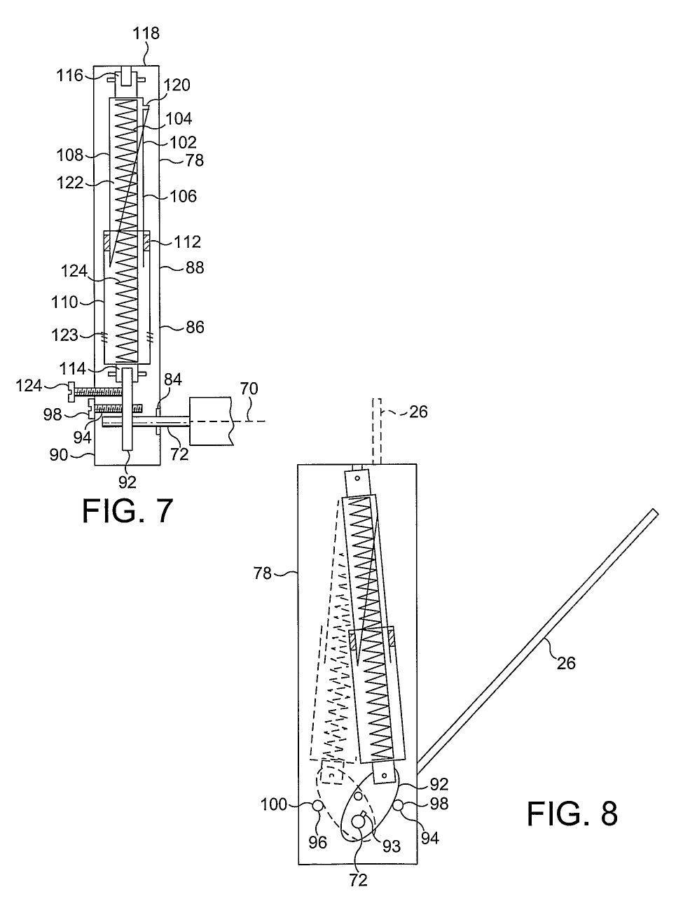

FIG. 7 is an enlarged, part sectional, schematic front elevation view of the closing mechanism for the hinged window of FIG. 1,

FIG. 8 is an enlarged, part sectional, schematic side elevation view of the closing mechanism of FIG. 7,

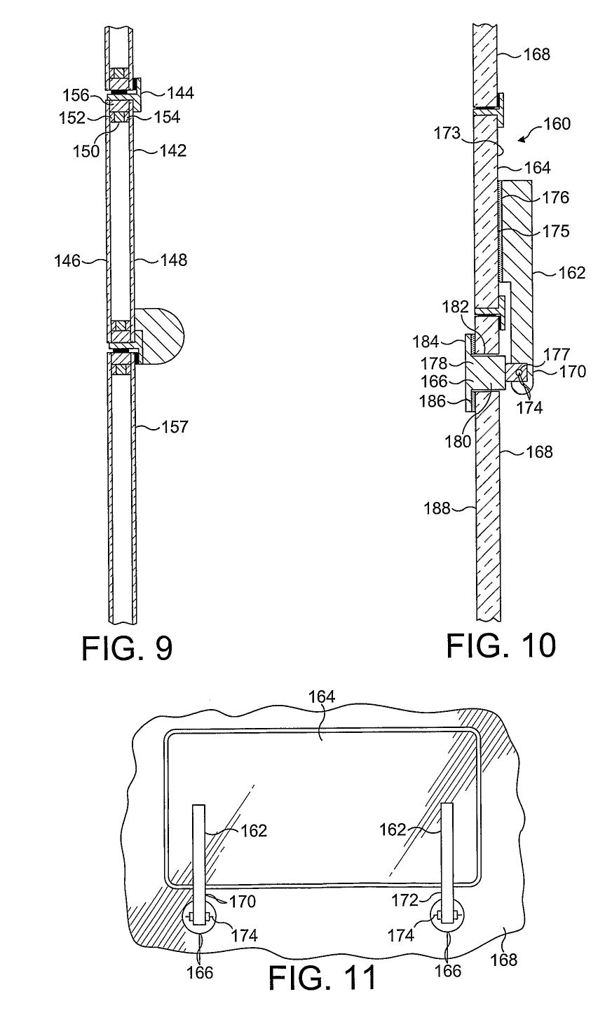

FIG. 9 is a schematic vertical section through a hinged window in a closed configuration in accordance with a second embodiment of the present invention,

FIG. 10 is a schematic vertical section through a hinged window in a closed configuration in accordance with a third embodiment of the present invention,

FIG. 11 is a schematic elevation view of the inside face of the hinged window of FIG. 10,

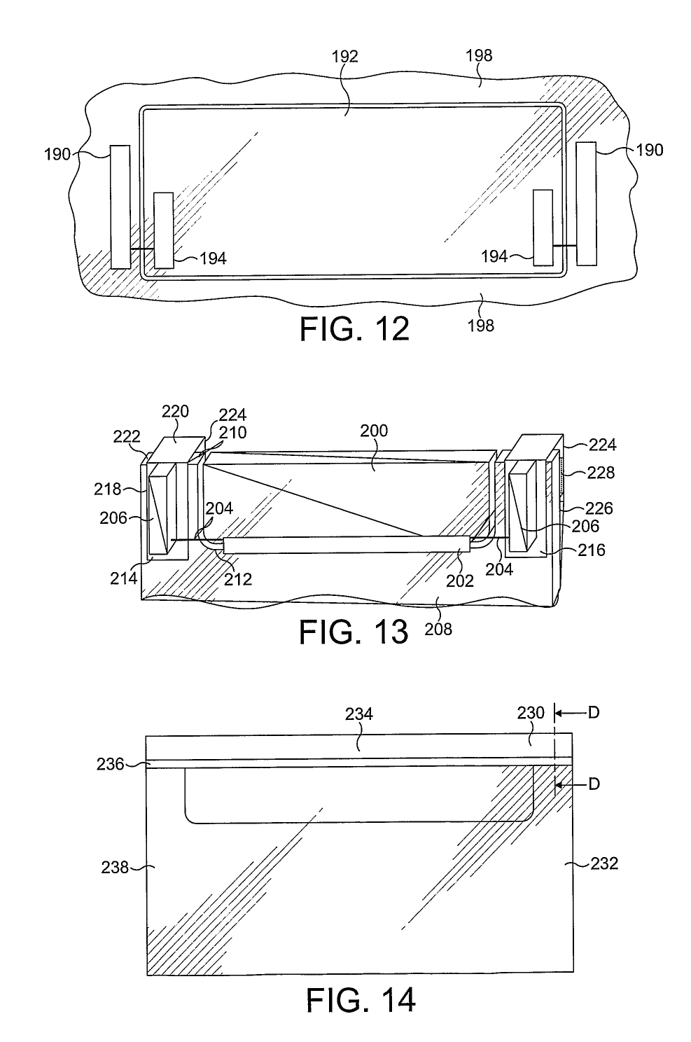

FIG. 12 is a schematic elevation view of the inside face of a hinged window in a closed configuration in accordance with a fourth embodiment of the present invention,

FIG. 13 is a schematic elevation view of the inside face of a hinged window in a closed configuration in accordance with a fifth embodiment of the present invention,

FIG. 14 is a schematic elevation view of the outside face of a hinged window in a closed configuration in accordance with a sixth embodiment of the present invention,

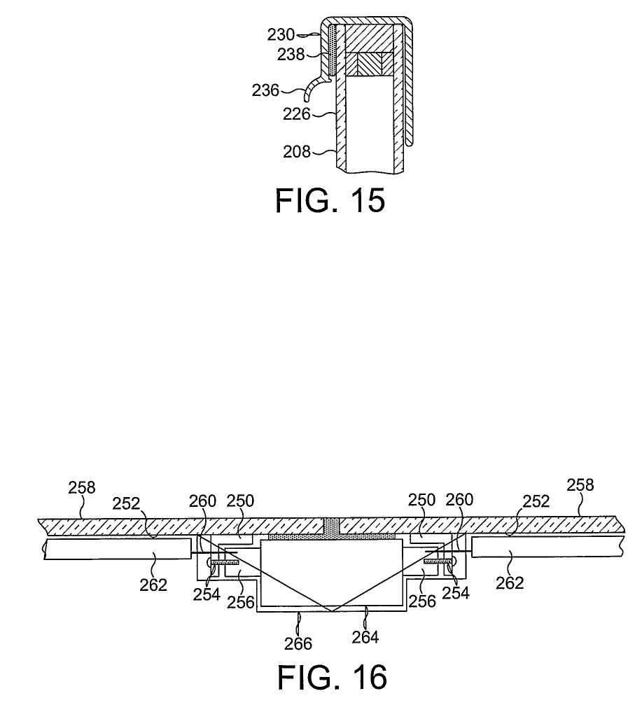

FIG. 15 is a schematic vertical section on line D-D of the hinged window of FIG. 14,

FIG. 16 is a schematic horizontal section through a hinged window in a closed configuration in accordance with a seventh embodiment of the present invention,

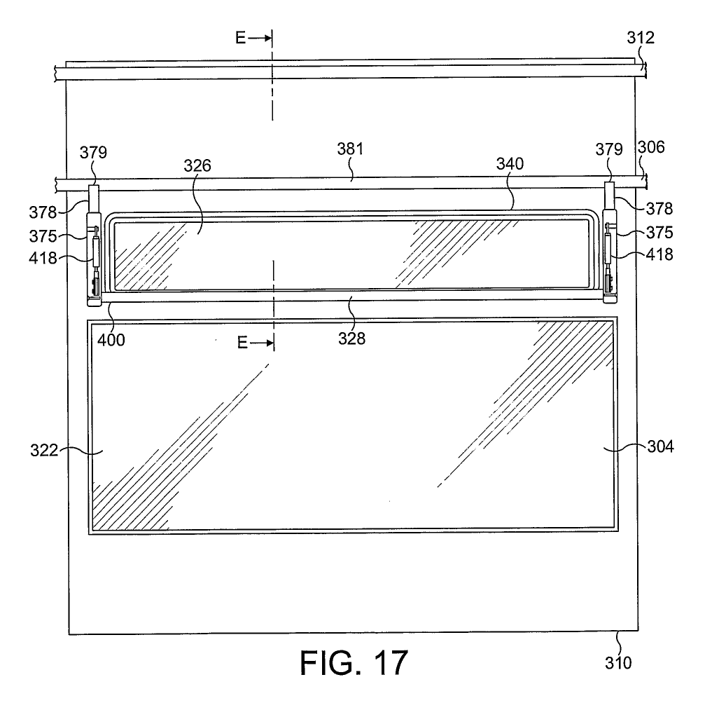

FIG. 17 is a schematic elevation view of the inside face of a hinged window in a closed configuration mounted in a bus in accordance with a eighth embodiment of the present invention,

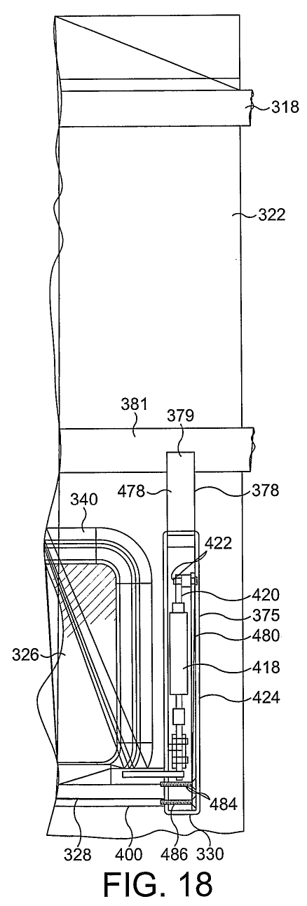

FIG. 18 is an enlarged schematic elevation view of one side of the inside face of the hinged window of FIG. 17,

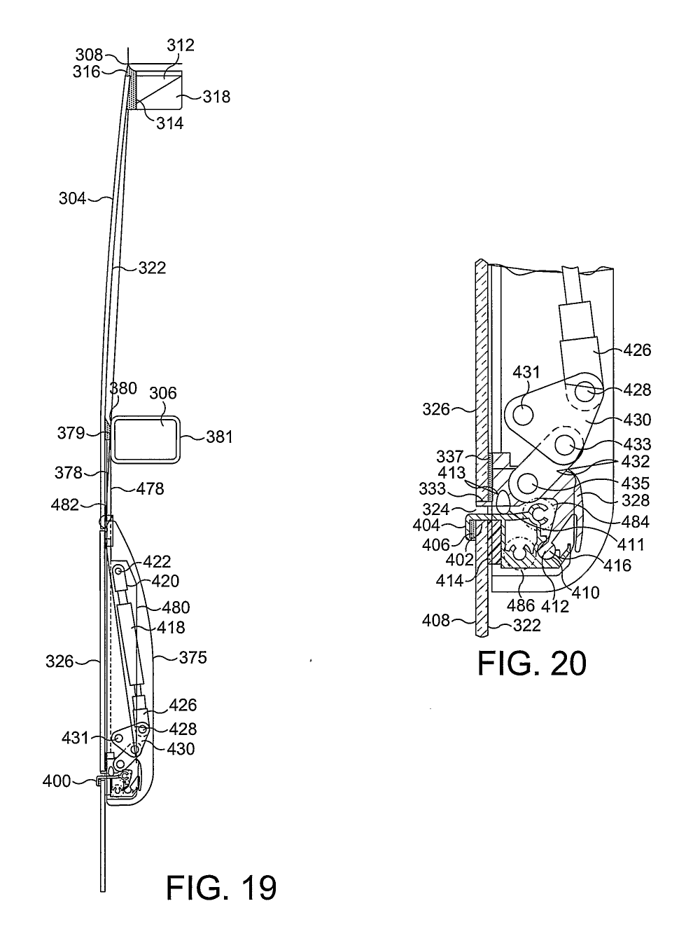

FIG. 19 is a schematic vertical sectional view on line E-E of the hinged window of FIG. 17,

FIG. 20 is an enlarged view of part of the hinge operating mechanism shown in FIG. 19,

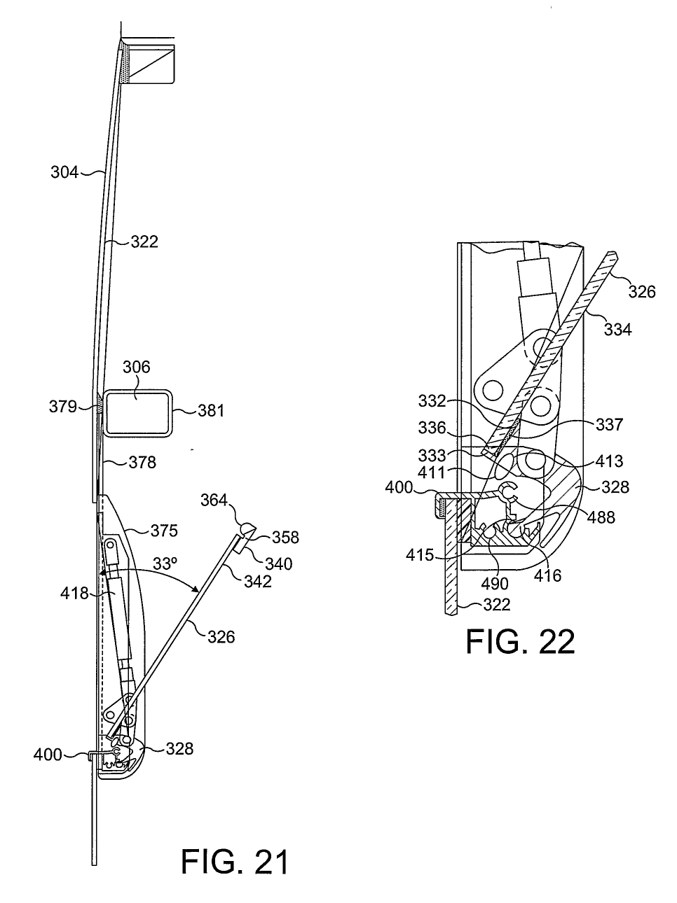

FIG. 21 is a schematic vertical sectional view on line E-E of the hinged window of FIG. 17 but in an open configuration, and

FIG. 22 is an enlarged view of part of the hinge operating mechanism shown in FIG. 22.

For ease of illustration, in the drawings the dimensions of the various parts of the hinged windows of the invention, and of the bus, are not necessarily shown in proportion. In particular, the thicknesses of various parts may be exaggerated.

Referring to FIGS. 1 to 3, there is shown an outer side of a bus 2 incorporating a series of hinged windows 4 for a vehicle in accordance with a first embodiment of the present invention. The bus 2 has a body 6 providing an elongate recess 8 in which the hinged windows 4 are sealingly fitted so as to be substantially flush with the body 6. Each window 4 has an outer periphery 10 which is sealed, in known manner, to flanges 12 of the vehicle body 6 which extend inwardly of the recess 8. Typically, a peripheral band 14 of adhesive, such as polyurethane adhesive, bonds an inner face of the window 4 to the flanges 12, and an annular seal 16 of adhesive, such as polyurethane adhesive, surrounds the outer periphery 10 of the window 4, so as to be located between the window 4 and the body 6, and between adjacent windows 4 which are butted together. Between adjacent windows 4, the flanges 12 are typically provided by vertical beams 18. The inner face of each beam 18 may be covered by a moulded profile 20, typically of plastics material, to improve the aesthetic appearance of the inside of the vehicle. Obscuration bands may be printed, in known manner, on the inner face of each window 4 so as to cover the fittings of the window and to improve the aesthetic appearance of the outside of the vehicle. The obscuration bands also cover the polyurethane adhesive/sealant so as to ensure that it remains flexible and reliably seals the glazings to the vehicle body to prevent water ingress.

The window 4 comprises a fixed glazing panel 22 having an opening 24 therein in which a moving glazing panel 26 is fitted. The fixed glazing panel 22 surrounds the moving glazing panel 26. The moving glazing panel 26 is hinged along a lower horizontal edge thereof at which a hinge bar 28 is fitted to the moving glazing panel 26. The hinge bar 28 rotates about a horizontal axis. The moving glazing panel 26 can be moved between a closed position which is shown in FIG. 5 and an open position which is shown in FIG. 6. The fixed glazing panel 22 and the moving glazing panel 26 are disposed, when the moving glazing panel 26 is closed, in a common vertical plane so that both panels are substantially flush with the vehicle body 6.

The fixed glazing panel 22 may be single or double glazed, as known in the art. The moving glazing panel 26 may also be single or double glazed. Typically, the glazings 22, 26 are composed of toughened glass.

Referring to FIGS. 4, 5 and 6, the hinge mechanism 30 at the inner side of an upper portion of one of hinged windows 4 of FIG. 1 is shown in greater detail.

The hinge mechanism 30 comprises the hinge bar 28, typically of metal such as steel, stainless steel or aluminium, which is bonded at an outer face 32 to the inside face 34 of the moving glazing panel 26 at a lower edge margin 36 thereof. The bonding is by an adhesive, such as a polyurethane adhesive. As is known in the art, such polyurethane adhesive adheres and seals the two parts together. A lower edge gasket 40, typically of an elastomer, is affixed to the lower peripheral edge 42 of the moving glazing panel 26. The lower edge gasket 40 seals, against water ingress, the gap 44 between the upper edge of the fixed glazing panel 22 and the lower peripheral edge 42 of the moving glazing panel 26 when the moving glazing panel 26 is closed, as shown in FIG. 5.

A lower inner gasket 46, typically of an elastomer, is disposed between a lower part 48 of the hinge bar 28 and the inside face 50 of the fixed glazing panel 22 at an upper edge margin 52 thereof. The lower inner gasket 46 may be affixed to either or both of the hinge bar 28 and the fixed glazing panel 22. The lower inner gasket 46 seals, against water ingress, the gap 54 between the inside face 50 of the fixed glazing panel 22 and the hinge bar 28 when the moving glazing panel 26 is open, as shown in FIG. 6.

The gaskets 40, 46 preferably have a central cavity (not shown) so as to be readily compressible,

A peripheral edge seal 56 extends around the edge of the moving glazing panel 26. The peripheral edge seal 56 may extend around the two sides and the upper edge only of the moving glazing panel 26, as shown in the drawings, or may alternatively extend entirely around the moving glazing panel 26, in which case the lower part of the peripheral edge seal 56 is covered by the hinge bar 28. The corners of the moving glazing panel 26 are rounded, typically with a minimum radius of 25 mm, which is required if the moving glazing panel 26 is composed of toughened glass. Therefore a single peripheral edge seal 56 can be bent around the corners.

The peripheral edge seal 56 comprises an elongate profile 58, typically of extruded metal such as aluminium. The elongate profile 58 is substantially T-shaped in section. One face of the upright part, and the adjacent face of the cross part, of the T-shaped elongate profile 58 are bonded, typically by a polyurethane adhesive, respectively to the peripheral edge 60 and the inside face 34 of the moving glazing panel 26. Gaskets 64, 66 are respectively affixed to the opposite face of the upright part, and the adjacent face of the cross part, of the T-shaped elongate profile 58. In this way, when the moving glazing panel 26 is closed, the peripheral edge seal 56 seals the edges of the moving glazing panel 26 against water ingress by the gaskets 64, 66 sealing against the fixed glazing panel 22.

The hinge bar 28 is mounted to rotate about a horizontal hinge axis 70. Two pivot bars 72 extend outwardly of the hinge bar 28 along the hinge axis 70, each at a respective end 74 of the hinge bar 28. The pivot bars 72 are rotationally fixed relative to the hinge bar 28, for example by having an end (not shown), which is received in a corresponding cavity (not shown) in the hinge bar 28, which is rectangular in section, carries a spline or is firmly press fitted into the cavity. Each pivot bar 72 has an opposite end 76 which is received in a respective hinge support 78. Each hinge support 78 is mounted to an inner surface 80 of the vehicle body 6 at a respective vertical edge of the fixed glazing panel 22. The mounting is typically by fixings such as bolts. Referring back to FIG. 3, hinge support 78 may be mounted to an inwardly directed face, such as front face 81 on beam 18, or on a sideways directed face, such as side faces 82 on beam 18.

The hinge supports 78 not only support the hinge bar 28 for rotational movement, but also apply a biasing force thereto so as to urge the moving glazing panel 26 towards the closed or open position, depending on its orientation.

Referring to FIGS. 7 and 8, the hinge support 78 is shown in detail. The pivot bar 72 is received in an annular bearing 84 located in a sidewall 86 of a housing 88 of the hinge support 78. If desired, the pivot bar 72 may also be received in a second annular bearing (not shown) provided in the opposite sidewall 90 of the housing 88. The pivot bar 72 is fitted to a rocking member 92, via a key 93 preventing relative rotational movement therebetween. The rocking member 92 rotates together with the pivot bar 72 about horizontal hinge axis 70. The rocking member 92 rotates about an arc defined between two opposed end positions. The end positions are defined by respective stop members 94, 96, typically comprising bolts 98, 100 against the shaft of which an edge of the rocking member 92 bears when in the respective end position. The stop members 94, 96 are adjustably mounted so that the end positions can be selectively adjusted.

As shown in FIG. 8, in a first end position of the rocking member 92, shown by a solid line, the moving glazing panel 26 is disposed in an open position and in a second end position of the rocking member 92, shown in phantom, the moving glazing panel 26 is disposed in a closed position.

A damped biasing assembly 102 includes a biasing element 104 which applies a biasing force to the rocking member 92 so as to urge the moving glazing panel 26 towards the closed or open position, and the bias is damped by a pneumatic damping device 106. The damping may however be otherwise achieved, such as by hydraulic damping. The pneumatic damping device 106 of the damped biasing assembly 102 comprises a telescoping cylinder 106 having a first tubular body 108 slidingly received in a second tubular body 110, with an annular seal 112 therebetween. An end 114 of the second tubular body 110 is rotatably fitted to the rocking member 92 and an opposite end 116 of the first tubular body 108 is rotatably fitted to an endwall 118 of the housing 88. A vent hole 120 is provided in the first tubular body 108. Compression and expansion of the telescoping cylinder 106 are pneumatically damped by restricted flow of air through the vent hole 120 out of and into, respectively, the central chamber 122 of the telescoping cylinder 106. The end 114 of the second tubular body 110 is rotatably fitted to the rocking member 92 at a location that is spaced from the horizontal hinge axis 70 so as to provide an eccentric fitting of the end 114 relative to the horizontal hinge axis 70. Accordingly, in each of the first and second end positions of the rocking member 92, the telescoping cylinder 106 is at its maximum expansion, and at a central position of the rocking member 92, between the first and second end positions, the telescoping cylinder 106 is at its minimum expansion. Therefore rotational movement of the rocking member 92 between the first and second end positions, and consequently movement of the moving glazing panel 26 between the open and closed positions, is damped by the pneumatic damping device 106.

An elongate spring, comprising a helical compression spring 124, is disposed within the central chamber 122 of the telescoping cylinder 106, and oriented substantially orthogonally to the horizontal hinge axis 70. The helical compression spring 124 applies an outwardly pushing bias to the first and second tubular bodies 108, 110. Accordingly, at the central position of the rocking member 92, between the first and second end positions, at which the telescoping cylinder 106 is at its minimum expansion, the helical compression spring 124 applies the maximum restoring biasing force, and thereby urges the rocking member 92 away from this unstable central position towards one of the first and second end positions, depending on the direction of rotational closing or opening movement of the moving glazing panel 26 applied by a user.

The amount of bias applied by the helical compression spring 124 may be adjustable by adjusting the length of the spring 124 captive in the chamber 122. This can vary the strength of the closing or opening force applied to the moving glazing panel 26. For example, the fitting location of the end 116 of the first tubular body 108 to the endwall 118 of the housing 88 may be translationally adjustable, or the second tubular body 110 (for example) may be adjustable in length, e.g. by comprising two parts threaded together, as at 123.

A locking member 124 is provided for locking the rocking member 92 at a particular angular orientation, and thereby the moving glazing panel 26 at a selected position. In this way, the moving glazing panel 26 can be selectively locked in a fully open, an intermediate partly open or a fully closed position. This avoids the need for a locking device to be fitted to the moving glazing panel 26 along an edge remote from the hinged edge (although this can be fitted if desired). Such a locking device is conventionally employed in known bus and train windows, for example. This known arrangement not only requires an additional fitting for the moving glazing panel, but also is generally not aesthetically pleasing.

In an alternative embodiment the closing and opening movement of the moving glazing panel 26 may be applied automatically, for example by an electric actuator such as a servomotor.

In a further alternative embodiment, a horizontal strip, for example of aluminium, may be provided that connects together the two hinge supports on the inside face of the window above the hinge bar and preferably above the top of the moving glazing panel. The strip may be attached to the fixed glazing panel. Such an attached strip can mount the hinge supports to the fixed glazing panel, thereby to provide a single unit, and ease installation into the vehicle

Referring to FIG. 9, this shows a hinged window 140 in accordance with a second embodiment of the present invention. This embodiment is similar to the first embodiment except that the moving glazing panel 142 is double glazed and the peripheral edge seal 144 extends around the entire periphery of the moving glazing panel 142. The moving glazing panel 142 includes, in known manner, two spaced panes 146, 148, e.g. of toughened glass, separated by a peripheral spacer 150, with opposed primary seals 152, 154 between the spacer 150 and the respective glass pane 146, 148, and with an outer secondary seal 156 between the two spaced panes 146, 148 surrounding the spacer 150. The double glazed fixed glazing panel 157 has a similar construction.

By mounting the hinge mechanism for the moving glazing panel on the vehicle body, the hinge mechanism is capable of securely bearing the additional weight of a double glazed unit for the moving glazing panel, as compared to the single glazed unit conventionally employed in the prior art. Moreover, by providing the biasing mechanism remote from the hinge itself, the restoring force can be sufficiently large to be able reliably to move the moving glazing panel between the closed and opened positions, in particular so as reliably to push and keep the moving glazing panel in a closed position. Yet further, by providing a strong hinge mechanism and a strong restoring force by the biasing mechanism, the moving glazing panel may have a larger area, in particular so as to have a larger vertical height, than moving glazing panels of typical prior art constructions. This enhances the ventilation potential and the visible appearance of the windows.

Furthermore, unlike some known constructions, the hinge mechanism and the biasing mechanism are not required to be borne by the fixed glazing panel, in particular the portion of the fixed glazing panel beneath the moving glazing panel. This means that in the windows according to these embodiments, the structural demands on the fixed glazing panel are lower as compared to some known constructions. This in turn means that the fixed glazing panel may be made of thinner glass panes, for example 3 mm thick glass panes for a double glazed fixed glazing panel, than known constructions. This saves weight, reduces costs and can improve the visual appearance of the window.

Yet further, by providing a biasing mechanism remote from the hinge, not only can the bias be more controllably delivered, as compared to the snapping arrangements in the prior art, but also the bias can be additionally damped. This provides a smooth controllable assembly that is convenient to use. The remote biasing mechanism also provides the technical advantages as compared to known constructions that the conventional catch member at the upper edge of the hinged glazing can be eliminated and the annular position of the moving glazing can be selectively locked at any desired end or intermediate position by using a locking device integral with the biasing mechanism.

Since the biasing mechanism is remote form the horizontal hinge, the visual impact of the hinge is reduced as compared to known windows, and an obscuration band may not be required on the upper edge of the fixed glazing, but only along the lower edge of the moving glazing so as to hide the hinge bar affixed thereto.

Since the moving and fixed glazings are not directly attached to each other, if one of the glazings requires replacement, it may be individually replaced, for example by the vehicle owner, without requiring the entire window to be replaced, as required by known windows where the two moving and fixed glazings are connected together by a complicated factory fitted biased hinge assembly.

Referring to FIGS. 10 and 11, these show a hinged window 160 in accordance with a third embodiment of the present invention. This embodiment is a modification of that of FIG. 1, in that instead of the hinge supports being mounted on the vehicle body and a hinge bar being affixed to the moving glazing panel, the hinge supports 162 are affixed to the moving glazing panel 164 and, instead of a single hinge bar, a pair of hinge mounts 166, one for each hinge support 162, is provided which hinge mounts 166 are affixed to the fixed glazing panel 168. The hinge mount 166/hinge support 162 assemblies are spaced apart to provide two separate hinges 170, 172 for the moving glazing panel 164, each having a common hinge axis 174 about which the moving glazing panel 164 is rotated relative to the fixed glazing panel 168.

As shown in FIG. 10, the hinge support 162, which includes a damped biasing assembly (not shown) similar to that of the first embodiment is bonded at one face 175 thereof to the inside face 173 of the moving glazing panel 164, for example by polyurethane adhesive 176. The hinge support 162 is pivotally attached by a pivot 177 to the respective hinge mount 166. The hinge mount 166 comprises a boss member 178 that has a central part 180 extending through a hole 182 in the fixed glazing panel 168, and an outer flange part 184 the inner face of which is bonded, for example by polyurethane adhesive 186, to the outside face 188 of the fixed glazing panel 168. The central part 180 typically has a diameter of about 50 mm. Therefore the hinges 170, 172 are carried on the outside face 188 of the fixed glazing panel 168.

This embodiment provides the advantage that the hinge assembly is less visually obtrusive than in the previous embodiments because no hinge bar extends across the window. However, if the fixed glazing panel breaks, there is no support for the moving glazing assembly. This problem could be overcome by providing a relatively narrow horizontal bar attached to the boss members 178 and to the vehicle body on opposed sides of the window. The bar would extend horizontally substantially along the junction between the fixed and moving glazing panels, and the upper inside face of the fixed glazing panel could be bonded to the bar.

FIG. 12 is a schematic elevation view of the inside face of a hinged window in a closed configuration in accordance with a fourth embodiment of the present invention, which is a modification of the third embodiment. In contrast to the third embodiment, the hinge supports 190 are affixed to the fixed glazing panel 196, each on an opposed side of the moving glazing panel 192 of the window 198, as in the first embodiment, and the pair of hinge mounts 194, one for each hinge support 190, is affixed to the moving glazing panel 192, for example by bonding as in the first embodiment. Alternatively, the hinge supports may be affixed to the vehicle body. This embodiment provides the advantage that no hinge bar extends across the window.

In each of the previous embodiments, the fixed glazing panel has a closed opening in which the moving glazing panel is received so that the fixed glazing panel surrounds the moving glazing panel. This is visually attractive, but can lead to difficulties in that if the fixed glazing panel breaks, there may be no support for the moving glazing assembly. In the additional embodiment of FIG. 13, the upper edge of the fixed glazing panel is substantially U-shaped and the moving glazing panel is received in the central depression of the U-shape. The moving glazing panel can be mounted to the vehicle body so that if the fixed glazing panel breaks, there is still support for the moving glazing assembly on the vehicle body.

Referring to FIG. 13, in the same manner as provided for the embodiment of FIG. 1, the moving glazing panel 200 is mounted at its lower edge to a hinge bar 202 having opposed outwardly extending pivot bars 204 and the pivot bars 204 are respectively received in a pair of hinge supports 206, each incorporating a damped biasing assembly (not shown). The fixed glazing panel 208 has an upper edge 210 which defines a central depression 212 in which the moving glazing panel 200 is received. As for the other embodiments, peripheral edge seals and gaskets (not shown) are provided between the moving and fixed edge panels 200, 208 to seal against water ingress. The hinge supports 206 are affixed to respective downwardly depending support members 214, 216. These support members 214, 216 are substantially upside-down U-Shaped and have an inward flange 218 to which the respective hinge support 206 is affixed, a top web 220 extending across the upper edge 222 of the fixed glazing panel 208 and an outward flange 224 extending downwardly along the outer face 226 of the fixed glazing panel 208 and adhered thereto by a layer of adhesive 228, such as polyurethane adhesive.

The downwardly depending support members 214, 216 are affixed, by adhesive/sealant as disclosed with respect to the embodiment of FIG. 1, to the vehicle body when the window is fitted to the vehicle.

In a modification, as shown in FIG. 14, the downwardly depending support members 214, 216 may be part of a common strip 230 which extends along the width of the window 232 and has an outer face 234 incorporating an integral bottom lip 236 which assists in diverting rainwater away from the outer face 238 of the window 232. FIG. 15 shows the configuration of the lip 236 in greater detail.

In each of the embodiments of FIGS. 13 to 15, the provision of the downwardly depending members, separate or incorporated into a common strip, that mount the moving glazing panel to the vehicle body ensures that if the fixed glazing panel breaks, there is still support for the moving glazing assembly on the vehicle body. The downwardly depending members also assist the manufacture of the vehicle window and its assembly into the vehicle. The downwardly depending members, separate or incorporated into a common strip, provide a single assembly of the fixed and moving glazing panels. Consequently, the entire hinged window is pre-assembled as a single unit and can readily be inserted into the window opening of the vehicle body in a single operation.

In other embodiments where the moving panel is received in a closed opening within the fixed panel, the common strip which extends along the width of the window at its upper edge and has an outer face incorporating an integral bottom lip may additionally be provided, either separately, or connected to the hinge mechanism of the moving glazing panel, for example connected to the hinge supports of FIG. 12. This latter interconnection assembly ensures that for the embodiments where a closed opening for the moving glazing is provided, if the fixed glazing panel breaks there is still support for the moving glazing assembly on the vehicle body, and the entire hinged window is pre-assembled as a single unit and can readily be inserted into the window opening of the vehicle body in a single operation during manufacture of the vehicle.

FIG. 16 shows a modification to the embodiment of FIG. 1 which additionally assists manufacture of the vehicle by providing that the entire hinged window is pre-assembled as a single unit and can readily be inserted into the window opening of the vehicle body in a single operation during manufacture of the vehicle.

In this modification, two L-shaped profiles 250 are affixed, for example by adhesive, to the inner face of the fixed glazing panel 252. Each L-shaped profile 250 has temporarily attached thereto, for example by screws 254, a respective hinge support 256. Each hinge support 256 is temporarily attached at a location substantially corresponding to its location in the ultimate window assembly in the vehicle. Accordingly, the L-shaped profile 250 temporarily connects together the respective hinge support 256 and the fixed glazing panel 252, and the hinge supports 256 are also connected to the moving glazing panel 258 by means of the pivot bars 260 and the hinge bar 262. This temporarily assembled configuration permits the entire hinged window to be supplied as a single unit, and assembled into a vehicle as a single unit. The L-shaped profiles 250 provide a visual guide to assist accurate location of the window in the vehicle opening. After such location, the L-shaped profiles 250 are detached from the respective hinge supports 256, by removing the screws 254, which are then affixed to the vehicle body 264. The hinge supports 256 and the L-shaped profiles 250 may be concealed by a trim 266 fitted to the inside of the vehicle body 264.

FIGS. 17 to 22 show a hinged window mounted in a bus in accordance with an eighth embodiment of the present invention. In FIGS. 17 and 18 the inside face of the hinged window in a closed configuration is shown.

Referring to FIGS. 17 to 22, there is shown an inner side of a bus window 304 mounted to the vehicle body 306 providing a recess 308 in which the window 304 is sealingly fitted so as to be substantially flush with the body 306. Plural such windows 304 are provided along each side of the bus. Each window 304 has an outer periphery 310 which is sealed, in known manner and similar to the previous embodiments, to flanges 312 of the vehicle body 306 which extend inwardly of the recess 308. Typically, a peripheral band 314 of adhesive, such as polyurethane adhesive, bonds an inner face of the window 304 to the flanges 312, and an annular seal 316 of adhesive, such as polyurethane adhesive, surrounds the outer periphery 310 of the window 304, so as to be located between the window 304 and the body 306, and between adjacent windows 304 which are butted together. The upper flanges 312 are typically provided by a horizontal beam 318. Obscuration bands may be printed, in known manner, on the inner face of each window 304 so as to cover the fittings of the window and to improve the aesthetic appearance of the outside of the vehicle. The obscuration bands also cover the polyurethane adhesive/sealant so as to ensure that it remains flexible and reliably seals the glazings to the vehicle body to prevent water ingress.

The window 304 comprises a fixed glazing panel 322 having an opening 324 therein in which a moving glazing panel 326 is fitted. The fixed glazing panel 322 surrounds the moving glazing panel 326. The moving glazing panel 326 is hinged along a lower horizontal edge thereof at which a hinge bar 328 of a hinge mechanism 330 is fitted to the moving glazing panel 326. The hinge bar 328 rotates about a horizontal axis and the hinge mechanism 330 is mounted to the fixed glazing panel 322 and to the vehicle body 306. The moving glazing panel 326 can be moved between a closed position which is shown in FIGS. 17, 18, 19 and 20 and an open position which is shown in FIGS. 21 and 22. The fixed glazing panel 322 and the moving glazing panel 326 are disposed, when the moving glazing panel 326 is closed, in a common vertical plane so that both panels are substantially flush with the vehicle body 306.

As for the previous embodiments, the fixed glazing panel 322 may be single or double glazed, as known in the art. The moving glazing panel 326 may also be single or double glazed. Typically, the glazings 322, 326 are composed of toughened glass.

Referring to FIGS. 19 to 22, the hinge mechanism 330 is shown in greater detail.

A pair of hinge supports 378 is provided, each one being at a respective side of the moving glazing panel 326. Each hinge support 378 comprises a vertically oriented plate 478, parallel to the adjacent glass surface of the fixed glazing panel 322, and an integral inwardly directed flange 480 orthogonal thereto. Each hinge support 378 is mounted at an upper end 379 thereof, which is part of the plate 478, to an outwardly-facing surface 380, such as on a horizontal support beam 381, of the vehicle body 306 located inwardly of a respective vertical edge of the fixed glazing panel 322. In a modification however where the moving glazing panel 326 is disposed towards the top of the window 304, the beam 381 is not present and each hinge support 378 is mounted at the upper end 379 thereof to the flange 312 of the vehicle body 306. The mounting is typically by adhesive. The hinge supports 378 therefore depend downwardly from a part of the body 306 adjacent the window 304.

The hinge supports 378 are not directly attached to or carried by the fixed glazing panel 322. However, a seal 482, for example of rubber, may be provided between the outwardly facing surface of the plate 478 and the adjacent glass surface of the fixed glazing panel 322.

A horizontal mount 400 is disposed between the hinge supports 378. At each end of the horizontal mount 400, two bolts 484, 486 are provided which extend through mounting holes in the flange 480 of the respective hinge support 378 and are received in respective couplings 488, 490 of the horizontal mount 400. In this way, the horizontal mount 400 is securely fitted to the body 306 via the hinge supports 378. The horizontal mount 400 is mounted so as to sit on the upwardly facing edge 402 of a lower edge of the opening 324 and has an integral downwardly extending lip 404 that is affixed by adhesive 406 to a horizontal strip of the outer face 408 of the fixed glazing panel 322 extending along the lower edge of the opening 324. The mount 400 thereby has an elbow portion, with the lip 404 being an end part adjacent to the outer face of the fixed glazing panel along a lower edge of the opening 324 and the adjacent part disposed against the upwardly-facing edge 402 of the fixed glazing panel 322. In this way, the weight of the hinge mechanism 330 and of the moving glazing panel 326 is supported by the body 306 and the fixed glazing panel 322, in particular by the hinge mechanism 330 and being mounted on the body 306 and the outer face 408 of the fixed glazing panel 322, and along the width of the opening 324.

The horizontal mount 400 is disposed inwardly of the fixed glazing panel 322 and has formed therein a female part 410 of an elongate hinge 412 which is horizontally oriented and extends between the hinge supports 378. A plastic spacer 414 is disposed between the horizontal mount 400 and the fixed glazing panel 322.

The hinge mechanism 330 supports the moving glazing panel 326 for rotational movement between open and closed positions. In addition, a biasing mechanism applies a biasing force thereto so as to urge the moving glazing panel 26 towards the closed or open position, depending on its orientation.

The hinge bar 328, typically of metal such as steel, stainless steel or aluminium, is bonded at an outer face 332 to the inside face 334 of the moving glazing panel 326 at a lower edge margin 336 thereof. The bonding is by an adhesive 337, such as a polyurethane adhesive. The hinge bar 328 also includes an edge portion 333 that lies along and supports the downwardly-facing edge of the moving glazing panel 326. The hinge bar 328 is substantially L-shaped with the outer face 332 at one end thereof and has formed therein at the other end thereof a male part 416 of the elongate hinge 412. The male part 416 of the elongate hinge 412 is received within the female part 410 of the elongate hinge 412 so as to provide a secure and stable hinge extending along the width of the moving glazing panel 326 by the complementary hinge parts 410, 416 being fitted together.

An O-ring seal 411 is fitted into a downwardly directed cavity 413 of the hinge bar 328 which seals against an upper surface of the horizontal mount 400 to prevent water ingress along the elongate hinge 412 when the moving glazing panel 326 is closed.

At the two opposite ends of the hinge bar 328 there is a respective coupling to a respective hinge support 378. Each hinge support 378 carries a gas spring 418 which is substantially vertically oriented. An upper end 420 of the gas spring 418 is rotatably mounted to a fixed pivot 422 on the flange 480 of the respective hinge support 378, and a lower end 426 of the gas spring 418 is rotatably mounted to a movable pivot 428 which is on a rocker element 430 mounted to the respective hinge support 378. Each rocker element 430 is rotatably mounted to a fixed pivot 431 on the respective flange 480. The rocker element 430 is pivotally connected at a movable pivot 433 to a respective link element 432. In turn, the link element 432 is pivotally connected at a movable pivot 435 to a respective end of the hinge bar 328. The pivot 435 is elongated because the end of the hinge bar 328 is horizontally spaced from the link element 432 at that location, and in particular is inwardly spaced relative to the hinge support 378. A cover 375, for example of moulded plastic material, for the hinge mechanism 330 covers the lower part of the hinge support 378 and the gas spring 418, rocker element 430 and link element 432 carried thereon.

The upper face 415 of the male part 416 is flat, which enables removal and assembly of the moving glazing panel 326 in an open position when the gas springs 418 have been released.

The hinge bar 328 rotates about a first horizontal axis defined by the elongate hinge 412. The rocker elements 430 rotate about a second horizontal axis defined by the opposed fixed pivots 432. The rocker elements 430, link elements 432 and elongate hinge 412 permit the moving glazing panel 326 to be moved between the open and closed positions, typically having an angular separation defined by an arc of about 33 degrees. At substantially central location within that arc the position of the moving glazing panel 326 is unstable and the gas springs 418 act to bias the moving glazing panel 326 away from that substantially central location and towards either the open or closed position.

A peripheral edge seal 340 is affixed, for example by adhesive, to the peripheral inner edge 342 of the moving glazing panel 326 except at the location where the hinge bar 328 is affixed. The edge seal 340 seals against water ingress when the moving glazing panel 326 is closed. The corners of the moving glazing panel 326 are rounded, typically with a minimum radius of 25 mm, which is required if the moving glazing panel 326 is composed of toughened glass. The peripheral gasket edge seal 340 can either comprise a single element which can be bent around the corners, or alternatively comprises (as shown in the Figures) an assembly of straight parts and corner parts.

The peripheral edge seal 340 comprises an elongate profile 358, typically of extruded metal such as aluminium. The elongate profile 358 includes a cavity within which a gasket 364 is affixed. In this way, when the moving glazing panel 326 is closed, the peripheral edge seal 340 seals the edges of the moving glazing panel 326 against water ingress by the gasket 364 sealing against the fixed glazing panel 322.

It will be apparent to those skilled in the art that various modifications may be made to the disclosed embodiments without departing from the scope of the invention disclosed herein. Also, various features from the different embodiments may be combined or used interchangeably within the scope of the present invention.

1. A hinged window for a land vehicle, comprising a fixed glazing panel defining an opening therein, a moving glazing panel, a hinge mechanism attached to the moving glazing panel, the moving glazing panel being pivotally movable by said hinge mechanism between a closed position, at which the moving glazing panel is received in the opening, and an open position, and a biasing mechanism for urging said moving glazing panel towards the closed position, the biasing mechanism including at least one elongate spring extending substantially orthogonally to the pivot axis of the moving glazing panel relative to the fixed glazing panel.

2. A hinged window according to claim 1 wherein the biasing mechanism comprises a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the biasing mechanism biasing the rocking member selectively towards one of the first and second stop positions from a central unstable position of the rocking member.

3. A hinged window according to claim 1 wherein the biasing mechanism further includes a damping device for damping the pivotal movement of the moving glazing panel.

4. A hinged window according to claim 3 wherein the damping device comprises a pneumatic cylinder having a telescope configuration and a vent for controllably venting a central chamber of the pneumatic cylinder during compression and expansion of the telescope configuration.

5. A hinged window according to claim 4 wherein the at least one elongate spring is a mechanical disposed in the central chamber of the pneumatic cylinder.

6. A hinged window according to claim 5 wherein the length of the pneumatic cylinder is adjustable thereby to adjust the degree of bias applied by the at least one elongate spring.

7. A hinged window according to claim 1 wherein biasing mechanism is a gas spring.

8. A hinged window according to claim 1 wherein the biasing mechanism further includes a locking device for locking the angular position of the rotatable moving glazing panel.

9. A hinged window according to claim 1 wherein the hinge mechanism includes opposed pivot bars affixed to the moving glazing panel and the biasing mechanism includes two elongate springs, each mounted in a respective housing assembly and acting on a respective pivot bar.

10. A hinged window according to claim 9 wherein the opposed pivot bars extend from a hinge bar affixed to an edge of the moving glazing panel and each housing assembly of the biasing mechanism is mounted to the vehicle body.

11. A hinged window according to claim 10 wherein each housing assembly of the biasing mechanism is directly mounted to the vehicle body.

12. A hinged window according to claim 10 wherein each housing assembly of the biasing mechanism is indirectly mounted to the vehicle body via a mounting element disposed against the fixed glazing panel.

13. A hinged window according to claim 12 wherein the mounting element comprises at least one support disposed against an edge of the fixed glazing panel.

14. A hinged window according to claim 13 wherein the at least one support has an outer face presenting a lip for diverting rainwater away from the window surface.

15. A hinged window according to claim 9 wherein the opposed pivot bars are each attached to a respective hinge mount affixed to the fixed glazing panel and each housing assembly of the biasing mechanism is mounted to the moving glazing panel.

16. A hinged window according to claim 9 wherein the opposed pivot bars are each attached to a respective hinge mount affixed to the moving glazing panel and each housing assembly of the biasing mechanism is mounted to the fixed glazing panel.

17. A hinged window according to claim 1 wherein the hinge mechanism includes at least one hinge bar affixed to the moving glazing panel and a mount for the hinge bar, the mount being affixed to a portion of an outer face of the fixed glazing panel extending along an edge of the opening.

18. A hinged window according to claim 17 wherein the mount has an elbow portion, an end part being adjacent to the outer face of the fixed glazing panel along a lower edge of the opening and an adjacent part disposed against an upwardly-facing edge of the fixed glazing panel.

19. A hinged window according to claim 17 wherein the end part is adhered to the outer face of the fixed glazing panel.

20. A hinged window according to claim 17 wherein the hinge bar and the mount have complementary hinge parts fitted together.

21. A hinged window according to claim 17 wherein two biasing mechanisms are provided, each one on a respective side of the moving glazing panel, and the biasing mechanisms are mounted to the vehicle body.

22. A hinged window according to claim 21 wherein each biasing mechanism is indirectly mounted to the vehicle body via a mounting element disposed against the fixed glazing panel.

23. A hinged window according to claim 22 wherein the mounting element comprises at least one support disposed against of the fixed glazing panel and affixed to the vehicle body.

24. A hinged window according to claim 17 wherein each biasing mechanism comprises a gas spring.

25. A hinged window according to claim 17 wherein the biasing mechanism is connected to the hinge mechanism by a rocker member rotatable, about a pivot, between first and second positions, respectively corresponding to the closed and open positions of the moving glazing panel, the biasing mechanism biasing the rocker member selectively towards one of the first and second positions from a central unstable position of the rocker member.

26. A hinged window according to claim 25 wherein the rocker member is pivotally connected to the hinge bar by a linking element pivotally connected to the rocker member and the hinge bar.

27. A hinged window according to claim 1 wherein the opening in the fixed glazing panel is closed whereby the fixed glazing panel surrounds the moving glazing panel.

28. A hinged window according to claim 1 wherein the opening in the fixed glazing panel partially surrounds the moving glazing panel which is mounted at an edge of the window.

29. A hinged window for a land vehicle, comprising a fixed glazing panel defining an opening therein, a moving glazing panel, a hinge mechanism attached to the moving glazing panel, the moving glazing panel being pivotally movable by said hinge mechanism between a closed position, at which the moving glazing panel is received in the opening, and an open position, and a biasing mechanism for urging said moving glazing panel towards the closed position, the biasing mechanism including a damping device for damping the pivotal movement of the moving glazing panel.

30. A hinged window according to claim 29 wherein the biasing mechanism comprises a helical compression spring, and the damping device comprises a pneumatic cylinder having a telescope configuration and a vent for controllably venting a central chamber of the pneumatic cylinder during compression and expansion of the telescope configuration, and the helical compression spring is disposed in the central chamber of the pneumatic cylinder.

31. A hinged window according to claim 30 wherein the length of the pneumatic cylinder is adjustable thereby to adjust the degree of bias applied by the helical compression spring.

32. A hinged window according to claim 30 further comprising a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the helical compression spring biasing the rocking member selectively towards one of the first and second stop positions from a central unstable position of the rocking member.

33. A hinged window according to claim 32 further including a locking device for locking the angular position of the rocking member thereby to lock the position of the rotatable moving glazing panel.

34. A hinged window according to claim 29 wherein the biasing mechanism has an integral damping device and comprises a gas spring.

35. A hinged window according to claim 29 wherein the biasing mechanism is connected to the hinge mechanism by a rocker member rotatable, about a pivot, between first and second positions, respectively corresponding to the closed and open positions of the moving glazing panel, the biasing mechanism biasing the rocker member selectively towards one of the first and second stop positions from a central unstable position of the rocker member.

36. A bus, tram or train window, comprising a fixed glazing panel defining an opening therein, a moving glazing panel, a hinge mechanism attached to the moving glazing panel, the moving glazing panel being pivotally movable about a horizontal axis by said hinge mechanism between a closed position, at which the moving glazing panel is received in the opening, and an open position, the hinge mechanism comprising a pair of horizontally spaced hinges each mounted between the moving glazing panel and one of the fixed glazing panel and the vehicle body, a biasing mechanism for urging said moving glazing panel towards the closed position and a damping device for damping the pivotal movement of the moving glazing panel.

37. A hinged window according to claim 36 wherein the biasing mechanism comprises a helical compression spring, and a rocking member rotatable, about a hinge pivot fixed to the rocking member, between first and second stop positions, respectively corresponding to the closed and open positions of the moving glazing panel, the hinge pivot being fixed to one of the fixed and moving glazing panels, the helical compression spring biasing the rocking member selectively towards one of the first and second stop positions from a central unstable position of the rocking member.

38. A hinged window according to claim 36 wherein the damping device comprises a pneumatic cylinder having a telescope configuration and a vent for controllably venting a central chamber of the pneumatic cylinder during compression and expansion of the telescope configuration.

39. A hinged window according to claim 38 wherein the at least one elongate spring is disposed in the central chamber of the pneumatic cylinder.

40. A hinged window according to claim 36 wherein the biasing mechanism has an integral damping device and comprises a gas spring.

41. A hinged window according to claim 36 wherein the biasing mechanism is connected to the hinge mechanism by a rocker member rotatable, about a pivot, between first and second positions, respectively corresponding to the closed and open positions of the moving glazing panel, the biasing mechanism biasing the rocker member selectively towards one of the first and second stop positions from a central unstable position of the rocker member.

42. A hinged window according to claim 36 wherein in the bus, tram or train the hinges are each mounted between the moving glazing panel and the vehicle body, and further comprising fixings for temporarily attaching the hinge mechanism to the fixed glazing panel prior to attachment to the vehicle body.

43. A bus, tram or train window, comprising a fixed glazing panel defining an opening therein, a moving glazing panel, a hinge mechanism attached to the moving glazing panel, the moving glazing panel being pivotally movable about a horizontal axis by said hinge mechanism between a closed position, at which the moving glazing panel is received in the opening, and an open position, a biasing mechanism for urging said moving glazing panel towards the closed position, the hinge mechanism comprising a pair of horizontally spaced hinges each mounted between the moving glazing panel and the vehicle body whereby the moving glazing panel can be replaced with the fixed glazing panel fitted to the vehicle.

44. A hinged window according to claim 43 further comprising fixings for temporarily attaching the hinge mechanism to the fixed glazing panel prior to attachment to the vehicle body.

45. A hinged window according to claim 43 wherein the moving glazing panel is pivotally movable about a horizontal axis along a lower edge of the moving glazing panel, the lower edge of the moving glazing panel being adjacent an upper edge of the opening in the fixed glazing panel, and further comprising at least one gasket disposed between the lower edge of the moving glazing panel and the upper edge of the opening in the fixed glazing panel so as to seal the interior of the vehicle against water ingress along the adjacent lower and upper edges when the moving glazing panel is in the closed and open positions.

46. A bus, tram or train window, comprising a fixed glazing panel defining an opening therein and a moving glazing panel, both the fixed glazing panel and the moving glazing panel being double glazed units, a hinge mechanism attached to the moving glazing panel, the moving glazing panel being pivotally movable about a horizontal axis by said hinge mechanism between a closed position, at which the moving glazing panel is received in the opening, and an open position, the hinge mechanism being mounted between a lower horizontal edge of the moving glazing panel and the vehicle body, and a biasing mechanism mounted on the vehicle body for urging said moving glazing panel towards the closed position.

47. (canceled)

48. A bus, tram or train incorporating a window according to claim 1.
